(19) United States
(12) Patent Application Publication
(10) Pub. No.: US 2018/0085829 A1
(43) Pub. Date: Mar. 29, 2018

(54) ADJUSTING POROSITY IN POWDER METAL ARTICLES

(71) Applicant: Hamilton Sundstrand Corporation, Charlotte, NC (US)

(72) Inventor: Diana Giulietti, Tariffville, CT (US)

(21) Appl. No.: 15/278,048

(22) Filed: Sep. 28, 2016

(51) Int. Cl. B22F 3/24; B22F 3/105; B33Y 10/00; B33Y 40/00; B33Y 80/00

(52) U.S. Cl. CPC B22F 3/24; B22F 3/1055; B33Y 80/00; B33Y 40/00; B33Y 10/00

(57) ABSTRACT

A method of making an article includes coating an article formed using an additive manufacturing process technique, such as with laser sintering or a powder bed fusion technique. Pressure is thereafter applied to the coating and one or more surface-connected pores defined within the article are closed with the pressure. The coating is thereafter removed from the article.

### BACKGROUND OF THE INVENTION

1. Field of the Invention

The present disclosure relates powder metal articles, and more particularly to porosity in powder metal articles such as additively manufactured powder metal articles.

2. Description of Related Art

Additive manufacturing techniques are commonly used form components having relatively complex three dimensional geometries. Articles manufactured from additive manufacturing processes may have artifacts that are peculiar to the additively manufacturing technique used to fabricate the part, such as internal defects and relatively rough surface contours in comparison with parts fabricated using traditional subtractive techniques. Such artifacts can influence the mechanical properties of the part, such as by operating as a stress concentrator or riser, potentially reducing the expected fatigue life of the part.

Hot isostatic pressing (HIP) processes may be used to eliminate internal defects. Hot isostatic pressing is a process where heat and pressure are applied to a part. The heat renders material bounding the internal defects plastic, thereby enabling the pressure applied to the part to squeeze out the residual internal defects residual from the manufacturing process. HIP processes are generally effective on pores that are enclosed by the part. However, subsurface porosity, which can have interconnected passageways that are connected to the exterior of the part, can render HIP processes less effective at squeezing out such defects due to the response of such structure, and the influence of surface roughness on HIP processes.

Such conventional methods and systems have generally been considered satisfactory for their intended purpose. However, there is still a need in the art for improved additively manufacturing articles. The present disclosure provides a solution for this need.

### SUMMARY OF THE INVENTION

A method of making an article includes coating an article formed using an additive manufacturing process technique, such as with laser sintering or a powder bed fusion technique. Pressure is thereafter applied to the coating and one or more surface-connected pores defined within the article are closed with the pressure. The coating is thereafter removed from the article.

In certain embodiments, coating the article can include applying a thick coating over a surface of the article using a chemical vapor deposition technique. The coating can include a ceramic material. The coating can include vanadium carbide. The coating can have a thickness of between about 0.0001 inches (about 2.5 microns) and about 0.001 inches (about 25 microns). The coating can have a thickness of about 0.0005 inches (about 13 microns).

In accordance with certain embodiments, coating the article can include applying a conformal coating over the article surface and a surface-connected pore of the article. Coating the article can include closing off one or more surface-connected pore defined within the article with the coating material. Applying pressure to the article can include closing one or more pore defined within an interior of the article and not connected to a surface of the article. Applying pressure to the article can include closing one or more surface-connected pore with the pressure.

It is contemplated that, in accordance with certain embodiments, the method can include heating the article between the steps of coating the article and applying pressure to the article. The article can be heated while pressure is applied to the coated article. It is also contemplated that the article can be a gas turbine engine component, and applying pressure to the article can include matching one or more properties such as porosity, expected fatigue lifetime, and surface roughness of the article to porosity, expected fatigue lifetime, and surface roughness of a wrought article.

A method of making a gas turbine engine article includes coating a gas turbine engine article formed using an additive manufacturing process technique with a chemical vapor deposition technique. The coating includes vanadium carbide and has a thickness that is about 0.0005 inches (about 13 microns). Heat and isostatic pressure are applied the coated article, and one or more internal pore and one or more surface-connected pore are closed using the heat and isostatic pressure. The coating is thereafter removed from the article.

In certain embodiments, the article can be heated prior to applying pressure to the article. The article can be heated while applying pressure to the article. Applying pressure to the article can include matching one or more properties of the article to those of a wrought article. The matched properties can include one or more of porosity, expected fatigue lifetime, and surface roughness.

A gas turbine engine article includes a body with a coating. The body includes interfused metallic particulate with a surface bounding the interior of the body. The article interior defines one or more internal pores and one or more surface-connected pores. The coating is disposed over the surface of the body and includes vanadium carbide. The vanadium carbide coating has a thickness that is between about 0.0001 inches (about 2.5 microns) and about 0.001 inches (about 25 microns). In certain embodiments, the coating can encapsulate the body. In accordance with certain embodiments the coating spans and extends into at least a portion of the one or more surface-connected pores.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic cross-sectional side view of an exemplary gas turbine engine article according to exemplary embodiment constructed in accordance with the present disclosure, showing in an article having internal and surface-connected pores disposed within an interior of the gas turbine engine article;

FIG. 2 is a schematic cross-sectional view of the gas turbine engine article of FIG. 1, showing a coating being applied to the gas turbine engine article;

FIG. 3 is a schematic cross-sectional view of the gas turbine engine article of FIG. 1, showing heat being applied to the gas turbine engine article;

FIG. 4 is a schematic cross-sectional view of the gas turbine engine article of FIG. 1, showing internal pores and surface-connected pores within the article closing in response to isostatic pressure applied to the gas turbine engine article; and

FIG. 5 is a schematic cross-sectional view of the gas turbine engine article of FIG. 1, showing the coating being removed from the gas turbine engine article.

### DETAILED DESCRIPTION OF THE PREFERRED EMBODIMENTS

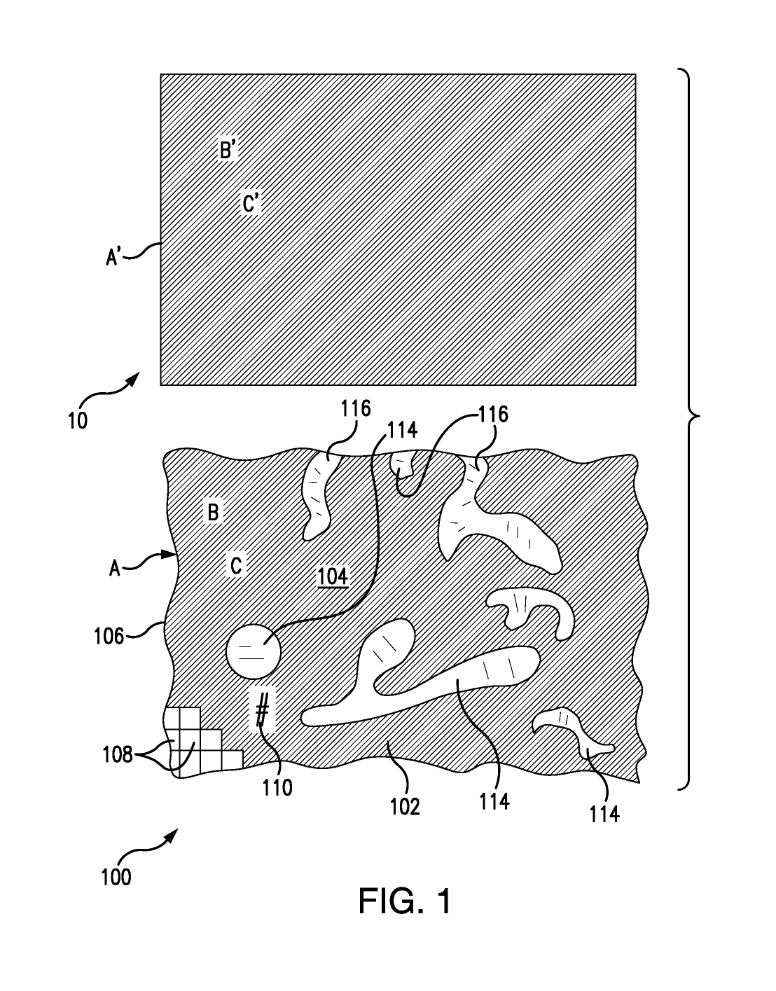

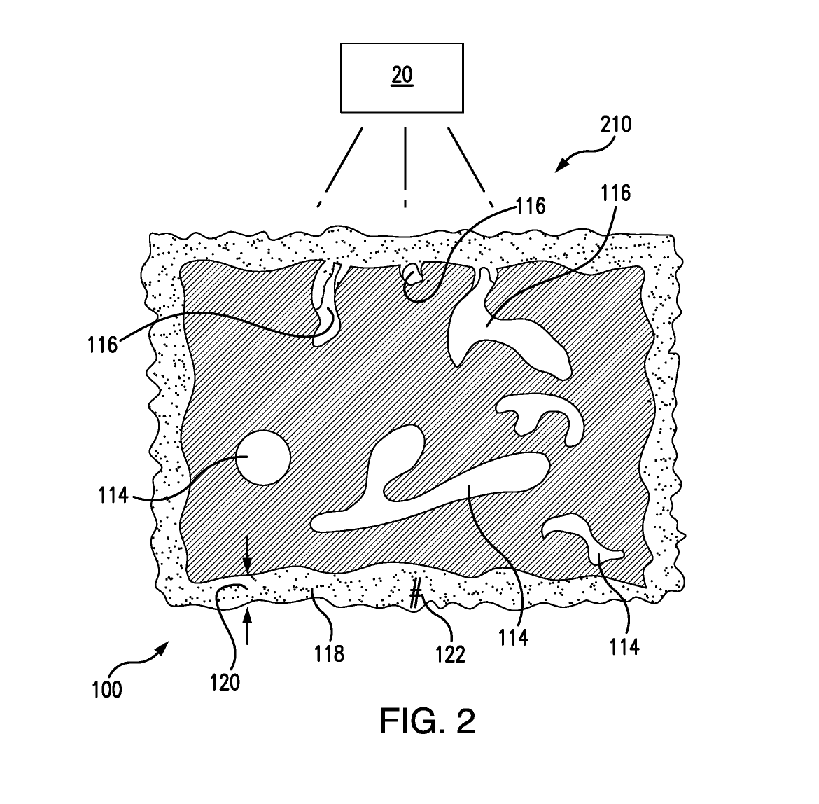

Reference will now be made to the drawings wherein like reference numerals identify similar structural features or aspects of the subject disclosure. For purposes of explanation and illustration, and not limitation, a partial view of an exemplary embodiment of method of making an fused metal particle article in accordance with the disclosure is shown in FIG. 1 and is designated generally by reference character 100. Other embodiments of methods of making additively manufactured articles and associated articles, or aspects thereof, are provided in FIGS. 2-5, as will be described. The systems and methods described herein can be used adjust the porosity of articles fabricated using additively manufacturing techniques, such as articles for gas turbine engines, though the present disclosure is not limited to gas turbine engine articles or to additive manufacturing techniques generally.

Referring to FIG. 1, an exemplary article, e.g., a gas turbine engine article 100, is shown. Article 100 includes a body 102 with an interior 104 and an external surface 106. Body 102 includes a plurality of interfused particles 108. Interfused particles 108 include a metallic material 110 such as aluminum, titanium, steel, and nickel-based alloy by way of non-limiting example. In the illustrated exemplary embodiment the interfused particles 108 are disposed in a plurality of interfused layers 112, such as results from progressively construction article 100 using a metal powder fusing technique, for example a metal injection method or an additive manufacturing technique such as powder bed fusion technique and or laser sintering. For purposes of illustration here body 102 is described as a body formed using an additive manufacturing technique.

Body 102 defines within interior 104 a plurality of voids, e.g., pores, fissures, microcrystalline non-homogeneities, etc. In this respect interior 104 of body 102 bounds one or more internal pores 114, which are isolated from the external environment by the metallic material 110 forming body 102. Interior 104 of body 102 also bounds one or more surface-connected pores 116, which are in communication with the external environment through external surface 106. Connection may via an aperture defined within external surface 106 that leads to a pore via one or more intervening voids or tortuously routed passages.

Body 102 has a plurality of properties which are artifacts of the process from article 100 was constructed. For example, body 102 has a surface roughness A, an expected fatigue lifetime B, and porosity C. As will be appreciated by those of skill in the art in the view of the present disclosure, the properties of body 102 when fabricated using an additive manufacturing technique may differ from the corresponding properties of an otherwise identical article produced using a conventional manufacturing technique, such as by a subtractive manufacturing technique applied to a forged article. An exemplary wrought article 10 is shown in FIG. 1, wrought article 10 being otherwise identical to article 100 absent properties corresponding with the different manufacturing technique used to fabricate wrought article 10. In this respect wrought article 10 has a surface roughness A′, an expected fatigue lifetime B′, and porosity C′ which each differ from the corresponding surface roughness A, an expected fatigue lifetime B, and porosity C of article 100.

As will be appreciated by those of skill in the art in view of the present disclosure, it can be desirable to match the properties of an additively manufactured article to those of an article manufactured using another technique, such as forging. Matching one or more properties of the additively manufactured article to the corresponding one or more properties of the corresponding article can simply acceptance (i.e. certification, etc.) as the part can be rendered identical (including variation) as opposed to improved (e.g., less variation). It is contemplated that, for example, surface roughness A of additively manufactured article 100 match that of wrought article 10 subsequent application the below-described methods to article 100.

With reference to FIGS. 2-5, a method 200 making an article, e.g., article 100 (shown in FIG. 1), is shown. Referring to FIG. 2, a step 210 for applying a coating 118 to article 100 is shown. Coating 118 is applied to external surface 106 of body 102. Coating 118 includes a ceramic material 122. Ceramic material 122 may be, by way of non-limiting example vanadium carbide. Vanadium carbide coating have the advantage of being amenable to application on fused metal articles as relatively thick coatings, enabling the coating to infiltrate surface-connected pores, facilitating closing infiltrated surface-connected pores. Vanadium carbide coatings can also be easily applied using vapor deposition techniques, and can generate coatings that are relatively hard in comparison to alternative coatings.

It is contemplated that coating 118 extend in a conformal layer over the entirety of external surface 106 of body 102. In this respect coating 118 extends into apertures defined within external surface 106 and leading into surface-connected pores as well as over the area defined by external surface 106. Conformal coatings have the advantage of spanning the surface roughness characteristic of certain types of additive manufacturing techniques, such as techniques used to form turbine blades from nickel-based alloys, and allows for reducing uniformly the native roughness of external surface 106. Conformal coatings can be developed on article 100 using, for example, diffusion techniques.

Coating 118 is a thick coating. In contemplated embodiments coating 118 has a thickness 120 that is between about 0.0001 inches (about 2.5 microns) and about 0.001 inches (about 25 microns). Coating thicknesses within this range provide suitable coverage for matching surface roughness of additively manufactured articles formed from aluminum, titanium, steel, and nickel-based articles. Coating thicknesses within this range also correspond with the size of surface-connected pores such that the surface-connected pores can be closed with heat and pressures that do not otherwise affect the properties of fused particle articles. In an exemplary embodiment, coating 118 has a thickness 0.0005 inches (about 13 microns). Coatings of this thickness provide statistical certainty that surface-connected pores, e.g., surface-connected pore 116, formed within surfaces of aluminum, titanium, steel, and/or alloy fused metal particle articles will be sufficiently plugged with ceramic material that the otherwise surface-connected pore will behave like an internal pore, e.g., internal pore 114, for purposes of hot isostatic pressing. Ceramic coatings having this thickness can be developed, for example, using a chemical vapor deposition technique, e.g., such as provided via exemplary coating apparatus 20.

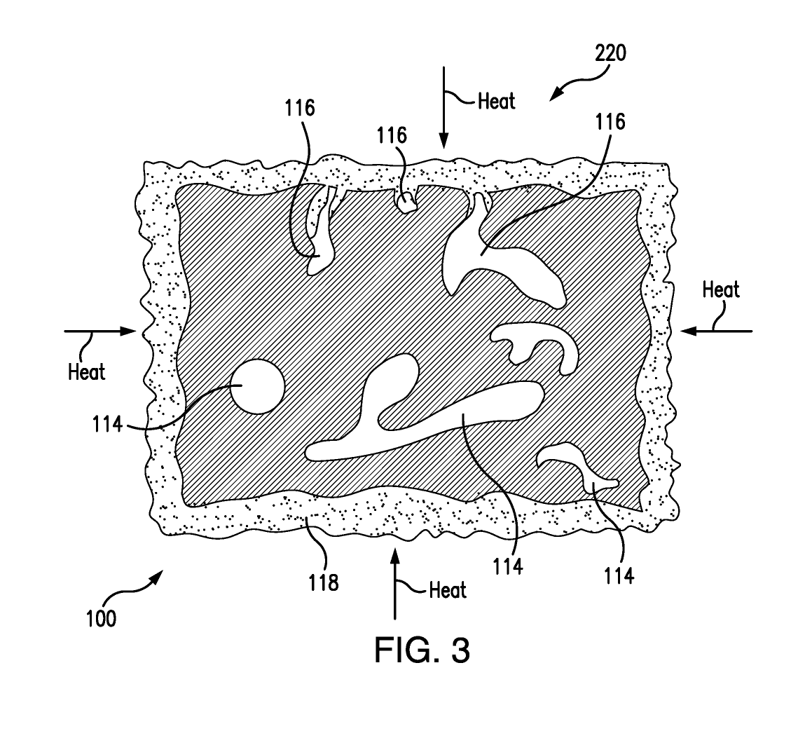

With reference to FIG. 3, a step 220 of heating coated article 100 is shown. Heating article 100 generally entails applying heat H to article 100. Heat H raises temperature article 100 to a predetermined temperature. It is contemplated that the temperature is below the melting point of the material forming the coated article, e.g., metallic material 110 (shown in FIG. 1), and that the temperature be above a temperature that the material undergoes plastic deformation in response to the application of pressure.

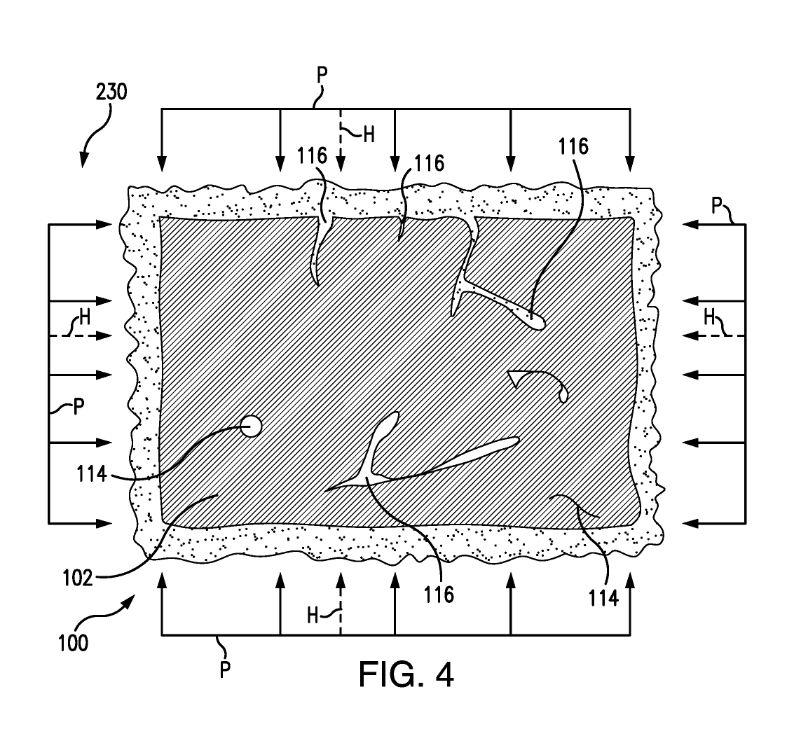

With reference to FIG. 4, a step 230 of pressing coated article 100 is shown. Pressing coated article 100 includes applying a pressure P to substantially the entire surface of coated article 100. Pressure may be applied by raising pressure of the external environment of coated article 100. It is also contemplated that the tensile strength of the thick ceramic coating apply pressure to article 100, coating 118 resisting the volumetric expansion that otherwise would be associated heating of the metallic material forming article material 100, e.g., metallic material 110. In certain embodiments the thickness of coating 118 is selected to apply pressure sufficient to close surface-connected pores 116 in cooperation with the heat H (shown with dashed arrows in FIG. 4), without the application external pressure.

As indicated by the relatively smooth external surface 106 shown in FIG. 4 in relation to FIGS. 1-3, pressure P reduces roughness of external surface. As also indicated with the smaller volume occupied by internal pore 114 and surface-connected pore 116, pressure P also ‘heals’ article 100 by closing internal pore 114 and surface-connected pore 116 disposed within body 102. As will be appreciated by those of skill in the art in view of the present disclosure, closing the pores causes the properties of article 100, e.g., roughness A (shown in FIG. 1), expected fatigue lifetime B (shown in FIG. 1), and porosity C (shown in FIG. 1) to change in relation that of the article prior to application of method 200.

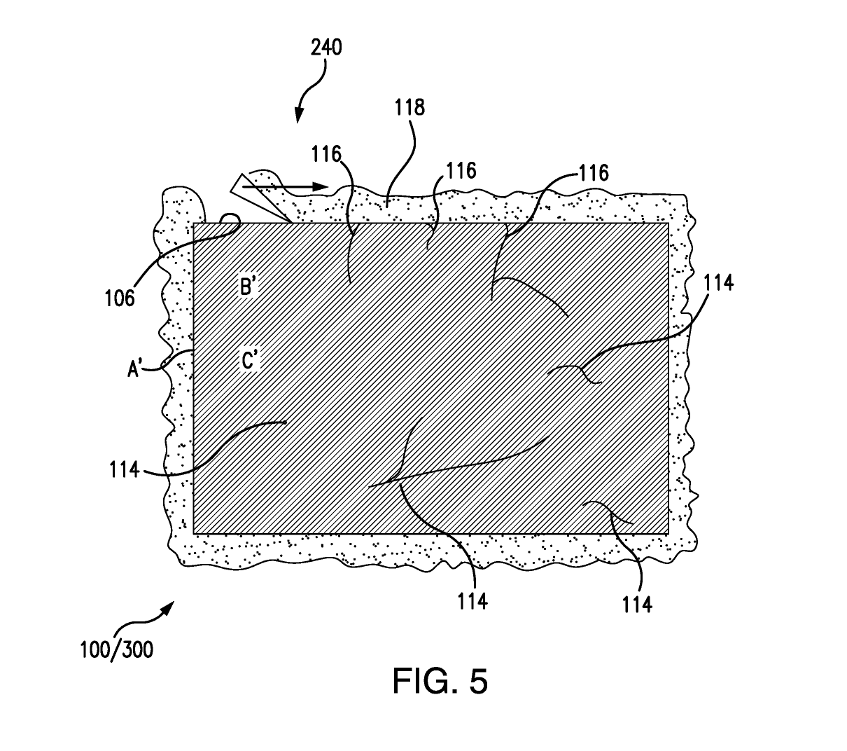

With reference to FIG. 5, a step 240 of removing coating 118 is shown. Once pressing is complete coating 118 can be removed. Although illustrated as a mechanical removal operation in FIG. 5, it is to be understood and appreciated that coating 118 can be removed chemically, such as by dissolving coating. Coating 118 can also be removed dynamically; such as by grit blasting, or any other suitable technique. Notably, heating article 100 (shown in FIGS. 3 and 4) may also include fracturing coating 118, thereby facilitating removal of coating 118. Once coating 118 is removed, an exemplary finished gas turbine engine article 300 has more closely matched (or matching) properties in relation to exemplary wrought article 10 (shown in FIG. 1).

Hot isostatic pressing can use heat and pressure to squeeze out residual porosity from an article from the manufacturing process used to form the article. Hot isostatic pressing can be relatively effective in closing internal defects, such as pores and voids. Subsurface porosity, such as surface-connected pores which may have interconnected passageways that are open to the exterior, can be resistant to closure using such techniques.

In embodiments described herein, subsurface porosity is healed by applying a thick vapor deposited coating to the external surface of an article. The coating, which can be a ceramic material such as vanadium carbide, can be applied to the surface of the article. The coating causes the surface connected pores to respond to pressurization, and in certain embodiments heating, such that the pores close. This can result in fully consolidated parts that more closely match the material properties of the wrought material, such as in expected fatigue lifetime.

The methods and systems of the present disclosure, as described above and shown in the drawings, provide for additively manufactured articles with improved properties such as properties matching those of forged counterpart articles. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method of making an article, comprising:
fusing metallic particulate to form an article;
coating the article;
applying pressure to the coated article;
reducing volume of surface-connected pores of the article; and
removing the coating from the article.

2. The method of claim 1, wherein coating an article includes applying a coating over a surface of the article using a chemical vapor deposition technique.

3. The method as recited in claim 1, wherein coating an article includes applying a vanadium carbide coating to the article.

4. The method as recited in claim 1, wherein coating an article includes coating a surface of the article with a coating having a thickness of between about 0.0001 inches (about 2.5 microns) and about 0.001 inches (about 25 microns).

5. The method as recited in claim 1, wherein coating an article includes coating a surface of the article with a coating having a thickness of about 0.005 inches (about 13 microns).

6. The method as recited in claim 1, further comprising heating the article prior to applying pressure to the article.

7. The method as recited in claim 1, further comprising heating the article while applying pressure to the coated article.

8. The method as recited in claim 1, wherein the article is a gas turbine engine component, wherein the gas turbine article has one or more properties substantially equivalent to that of a wrought article of equivalent composition.

9. The method as recited in claim 1, wherein applying pressure to the article includes applying isostatic pressure to the article.

10. The method as recited in claim 1, wherein fusing metallic particulate includes fusing particulate using an additive manufacturing technique.

11. The method as recited in claim 1, wherein fusing metallic particulate includes fusing particulate using a powder metal manufacturing technique.

12. The method as recited in claim 1, wherein coating the article includes infiltrating surface-connected pores of the article with the coating such that the coating extends into surface-connected pores defined within the article.

13. A method of making a gas turbine engine article, comprising:
coating a gas turbine engine article formed using an additive manufacturing process technique using a chemical vapor deposition technique;
applying heat to the article;
applying isostatic pressure to the coated article;
closing off one or more surface-connected pore defined within the article; and
removing the coating from the article, wherein the coating includes vanadium carbide, and wherein the coating has a thickness of about 0.0005 inches (about 13 microns) over the article surface and within one or more surface-connected pores defined within the article.

14. The method as recited in claim 13, further comprising heating the article between the steps of coating the article and applying isostatic pressure to the article and heating the article while applying isostatic pressure to the coated article.

15. The method as recited in claim 13, wherein coating the article includes infiltrating surface-connected pores defined within the article with coating material such that the coating extends into surface-connected pores defined within the article.

16. A gas turbine engine article, comprising:
a body comprising fused metallic particulate with a surface bounding an interior of the body, wherein the interior of the body defines one or more internal pore and one or more surface-connected pore; and
a coating disposed over the surface of the body, wherein the coating includes a ceramic material having a thickness between about 0.0001 inches (about 2.5 microns) and about 0.001 inches (about 25 microns).

17. The article as recited in claim 16, wherein the coating spans and extends into at least a portion of the one or more surface-connected pore.

18. The article as recited in claim 16, wherein the coating is conformal with the body surface and a surface-connected pore defined with the interior of the body.

19. The article as recited in claim 16, wherein the coating includes vanadium carbide.

20. The article as recited in claim 16, wherein the coating has a thickness that is about 0.0005 inches (about 13 microns).
